(19) United States
(12) Patent Application Publication
(10) Pub. No.: US 2007/0061139 A1
(43) Pub. Date: Mar. 15, 2007

(54) Interactive speech correcting method

(75) Inventors: Jia-lin Shen, Taipei (TW); Wen-wei Liao, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taipei (TW)

(21) Appl. No.: 11/450,569

(22) Filed: Jun. 9, 2006

(30) Foreign Application Priority Data
Sep. 14, 2005 (TW) 94131736

(51) Int. Cl. G10L 15/00

(52) U.S. Cl. 704/234

(57) ABSTRACT

An interactive speech correcting method is provided. The method includes the steps of (a) providing a reference speech, (b) receiving a user speech, (c) analyzing the user speech and the reference speech, (d) creating a speech parameter, (e) proceeding a speech correction by using the speech parameter and the user speech, and (f) outputting a corrected speech.

### FIELD OF THE INVENTION

The present invention is related to a language learning method and device, and more particularly, to a language learning method and device with a speech correcting function.

### BACKGROUND OF THE INVENTION

With the progress of the computer technique, the language learning has been performed in an electronic way. The user learns language by using the teaching software which is executed on the computer. The language learning includes four aspects, listening, speaking, reading, and writing. Basically, the language learning software can provide the correct answers for these four aspects as possible, and the user can correct his concepts according to the provided answers and be familiar with the corrected concepts. However, in speaking, the elder software could only provide the correct speech. Most users are usually not native speakers, so even if they have heard the correct speech for many times, they still can't handle the key of speech.

As for the current language learning software, the most common speech correcting software is performed by providing a correct sample speech. Then the software gives a score to show the distinction between the user speech and the sample speech, which helps the user distinguish if he makes progress in the speech correcting.

The advanced speech correcting software can analyze the properties of the user, such as the phoneme, length, volume, and intonation, and show the distinction, or error, between the user speech and the sample speech in each property. Then, the software provides an evaluation, or score, or a correct speech simultaneously. However, this method is still hard for the user to realize the mistakes he has made and how to pronounce correctly.

Please refer to FIG. 1, which illustrates a conventional speech correcting method. The software for the conventional speech correcting method comprises a reference speech 2 and a speech analysis function 3. When the user speech 1 is inputted into the hardware (not shown, usually a language learning machine or a computer), the speech analysis 3 is processed. Then the software will compare the user speech 1 with the reference speech 2, and then output a speech relative value 4 which is a score according to the distinction between these two speeches. A further analysis particularly separates the speech to four aspects, the phoneme, length, volume, and intonation, for prompting the user how to improve his speech. However, it is hard for the user to understand what the result calculated by the software means and improve his speech by using the values shown on the computer screen, since the values are not embodied as the speech. For example, when a foreigner learns Chinese, he usually cannot master the secret of pronunciation such as the stress, slight, and retro-flexion even if having listened the sample speech for many times. The learner speech is quite different from the reference speech in the phoneme, length, volume, and intonation. It is difficult for the learner to listen the sample speech and correct his speech defects simultaneously, since there exits too many defects in his speech.

Besides, since these language learning software provide so much information (the phoneme, length, volume, and intonation), the learner is hard to master all the secrets thereof and pronounce correctly. After a long time of frustration, the learner would be afraid of the language learning so that the learning effect would be reduced. Therefore, such a language learning method is not effective. Furthermore, the sample speeches in these software are mostly recorded by the native speakers so that the recorded sample speeches are certainly correct. For the non-native speakers, the best effect would be obtained by listening to the most standard speech in theory. However, after years of study, it is shown that the above-mentioned method is not the best strategy for language learning, because the learners will concentrate on learning the foreign speech but ignore the phoneme, length, volume, and intonation.

Therefore, the language learning software needs an improvement to help the user realize and improve his defects.

### SUMMARY OF THE INVENTION

It is an aspect of the present invention to provide an interactive speech correcting method. The method includes steps of (a) providing a reference speech; (b) receiving a user speech; (c) analyzing the user speech and the reference speech; (d) creating a speech parameter; (e) performing a speech correction by using the speech parameter and the user speech; and (f) outputting a corrected speech.

According to the interactive speech correcting method described above, the step (e) further comprises a contrast between the speech correction and the reference speech.

According to the interactive speech correcting method described above, the corrected speech is a corrected user speech.

According to the interactive speech correcting method described above, the reference speech comprises a reference phoneme, a reference length, a reference volume, and a reference intonation.

According to the interactive speech correcting method described above, the user speech comprises an original phoneme, an original length, an original volume, and an original intonation.

According to the interactive speech correcting method described above, the step (e) is performed by correcting the original phoneme, the original length, the original volume, and the original intonation on the basis of the reference phoneme, the reference length, the reference volume, and the reference intonation.

According to the interactive speech correcting method described above, the step (e) is performed by correcting one selected from the group consisting of the original phoneme, the original length, the original volume, and the original intonation to proceed correcting.

According to the interactive speech correcting method described above, the reference speech has a reference timbre and the user speech has an original timbre, and the step (e) corrects the reference timbre of the reference speech to make it become the same with the original timbre of the user speech to output through the step (f).

It is another aspect of the present invention to provide an interactive speech correcting method. The method comprises steps of (a) receiving a user speech; (b) correcting the user speech to form a new user speech; and (c) outputting the new user speech.

According to the interactive speech correcting method described above, the user speech comprises an original phoneme, an original length, an original volume, and an original intonation.

According to the interactive speech correcting method described above, the step (b) is based on a reference speech.

According to the interactive speech correcting method described above, the reference speech has a reference phoneme, a reference length, a reference volume, and a reference intonation and the step (b) is based on the reference speech.

According to the interactive speech correcting method described above, the step (b) further comprises a step (b.1): correcting one selected from the group consisting of the original phoneme, original length, original volume, and original intonation.

According to the interactive speech correcting method described above, the method after the step (b.1) further comprises a step (b.2): deciding a correcting scale based on the selected item of the step (b.1).

According to the interactive speech correcting method described above, the new user speech is a corrected voice of a user.

It is a further aspect of the present invention to provide an interactive speech correcting device. The device comprises a speech receiving device receiving an external speech; a controller connected to the speech receiving device and comprising a reference speech therein; and a loudspeaker outputting a corrected speech based on the reference speech.

According to the interactive speech correcting device described above, the controller comprises a storage device containing the reference speech, the external speech and the corrected speech, and a processing unit electrically connected to the storage device and correcting the external speech to form the corrected speech.

According to the interactive speech correcting device described above, the controller separates an original property from the external speech.

According to the interactive speech correcting device described above, the original property includes properties of an original phoneme, an original length, an original volume, and an original intonation.

According to the interactive speech correcting device described above, the controller only selects a candidate property to be corrected from the group consisting of the original phoneme, the original length, the original volume, and the original intonation properties.

According to the interactive speech correcting device described above, the controller further comprises a scale controller performing a staged correction to the candidate property.

According to the interactive speech correcting device described above, the reference speech further comprises a reference phoneme, a reference length, a reference volume, and a reference intonation to be a reference for the candidate property. It is further another aspect of the present invention to provide an interactive speech correcting method. The method is characterized in that an outputting standard speech is performed by simulating a user speech.

According to the interactive speech correcting method described above, the simulating step comprises steps of (a) setting a reference speech; (b) receiving the user speech; and (c) producing a corrected user speech by simulating the reference speech based on the user speech.

According to the interactive speech correcting method described above, the step (a) further comprises a step (0): providing a speech parameter.

According to the interactive speech correcting method described above, the speech parameter of the step (0) is gained from analyzing the user speech on the basis of the reference speech.

According to the interactive speech correcting method described above, the step (b) further comprises a step (b.1): correcting the speech parameter on the basis of the reference speech.

According to the interactive speech correcting method described above, the step (b) further comprises a step (b.2): segmenting the user speech on the basis of the speech parameter.

According to the interactive speech correcting method described above, the segmenting step is performed by cutting a wave pattern of the user speech.

According to the interactive speech correcting method described above, the step (b) comprises steps of (b.1) correcting the speech parameter on the basis of the reference speech; and (b.2) segmenting the user speech on the basis of the speech parameter, wherein a sequence of the step (b.1) and the step (b.2) is exchangeable.

According to the interactive speech correcting method described above, the reference speech comprises a reference phoneme, a reference length, a reference volume, and a reference intonation.

According to the interactive speech correcting method described above, only one from the group consisting of the reference phoneme, the reference length, the reference volume, and the reference intonation is selected to be corrected at a time.

Preferably, the interactive speech correcting method described above further includes a step of modulating a scale of the selected one.

According to the interactive speech correcting method described above, the speech parameter comprises an original phoneme, an original length, an original volume, and an original intonation.

According to the interactive speech correcting method described above, only one from the group consisting of the original phoneme, the original length, the original volume, and the original intonation is selected to be corrected at a time.

Preferably, the interactive speech correcting method described above further includes a step of modulating a scale of the selected one.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 illustrates a conventional speech correcting method;

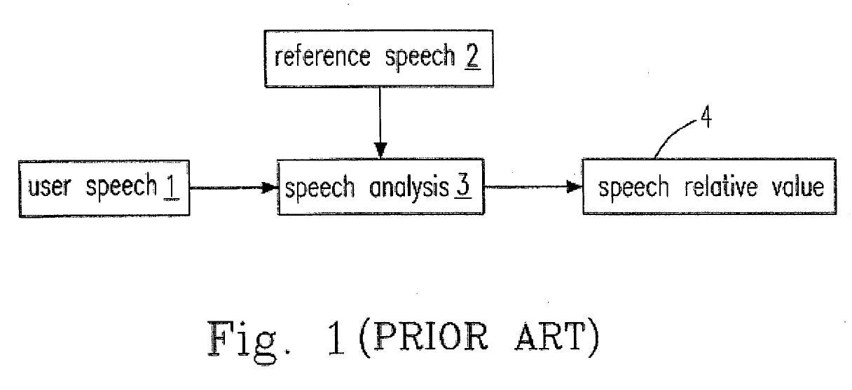

FIG. 2 illustrates the interactive speech correcting method of the present invention;

FIG. 3 illustrates how to correct speech in the present invention; and

FIG. 4 illustrates the interactive speech correcting device of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

To improve the conventional language learning devices, methods, or software, the present invention corrects the user speech and let the user hear the corrected speech with their own voice.

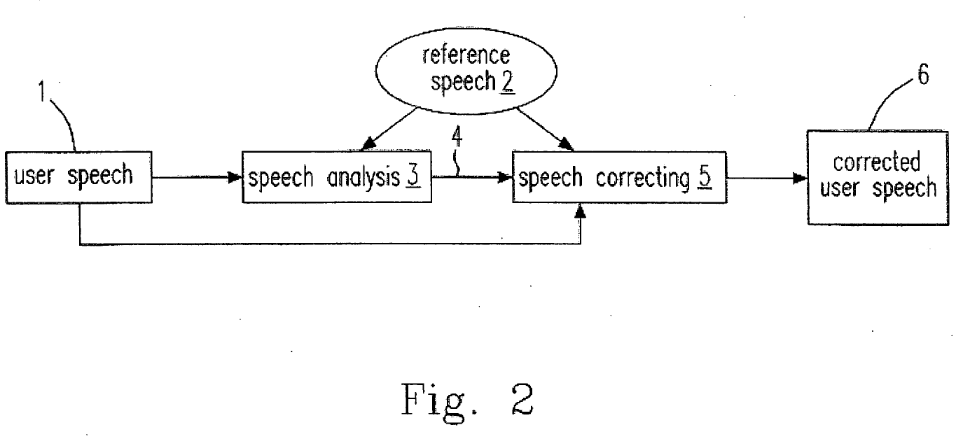

Please refer to FIG. 2, which illustrates the interactive speech correcting method of the present invention. Usually, the present invention is used in the hardware. At first, a user speech 1 is received, and then a speech correcting is performed for the user speech 1 to form a corrected user speech 6. Correcting the user speech 1 is performed under the condition that the user can recognize his own voice, thereby correcting the user speech 1 to pronounce a correct speech.

Please refer to FIG. 2 again. In order to correct the user speech 1, the present invention has a built-in reference speech 2 as a reference for correction. After a user speech 1 is received, a speech analysis 3 is performed based on the reference speech 2 at first. Usually, a voice has its own properties that are called the original properties before being corrected. That is, the speech analysis 3 analyzes the original properties directly. Further, the original properties can be separated to an original phoneme, an original length, an original volume, and an original intonation, etc. Although the present invention is illustrated based on these four properties at present, the other properties not listed in the present invention are still included therein. Moreover, to analyze the speech, the reference speech 2 also has the reference properties, i.e. a reference phoneme, a reference length, a reference volume, and a reference intonation. Therefore, the speech analysis 3 compares the original phoneme with the reference phoneme, the original length with the reference length, the original volume with the reference volume, and the original intonation with the reference intonation and analyzes these four properties. The most commonly used analysis is to indicate the difference between the original properties and the reference properties and measure how different they are. Then, a grading process is usually performed to grade the difference between the original properties and the reference properties, i.e. the less difference, the higher score.

Please refer FIG. 2 again. When the speech analysis 3 is finished, a speech parameter 4 is produced thereby. The speech parameter 4 represents the difference between the original properties and the reference properties described above. The next step is to use the speech parameter 4 to perform a speech correcting 5 for the user speech 1. The speech correcting 5 corrects the original properties to make it the same as the reference properties and outputs a corrected user speech 6, so that the user can hear the correct speech with his own voice.

Besides, for the users, they usually have their own properties such as the phoneme, length, volume and intonation which are different from the reference speech 2. If a given corrected user speech 6 with all properties corrected at once is provided for a user who initially contacts a foreign language, it would be unhelpful to him. Hence, the present invention has a step-by-step characteristic to correct the user speech 1, which prevents the user from feeling inadaptable caused by the huge difference between the corrected user speech 6 and the original user speech 1. Therefore, the present invention allows the user to select which property he wants to correct. If the selected property is the phoneme, the user can just correct the phoneme. Thus, the user only has to be concerned about how to correct the phoneme and could ignore other properties temporarily.

Therefore, the present invention corrects the user speech in a step-by-step way, so that the user would not feel embarrassed as they hear the sample speech, which is far different from his own speech, by using the conventional language learning software. Moreover, the present invention can not only select one specific property for correction, but also set the correcting scale for the selected property. Thus, the user can correct the selected property gradually and further understand the speech properties of the language. It has quite a good effect for language learning.

Please refer FIG. 2 again. After the speech analysis 3 is performed for the user speech 1, the speech correcting 5 is performed. Of course, in the process of speech correcting 5, the reference speech 2 and the user speech 1 are also used for assistance. After the user selects at least a property from the phoneme, length, volume, and intonation and sets the correcting scale thereof, the present invention outputs a corrected user speech 6. The corrected user speech 6 is based on the user speech 1 and corrected with the selected property, so the user can hear his own voice with the correct selected property. Of course, if the whole properties are selected and corrected, the user can hear his own voice with the whole correct selected properties. Hence, the user can feel kind to hear his own voice with the correct speech. This is greatly helpful to the speech of language learning.

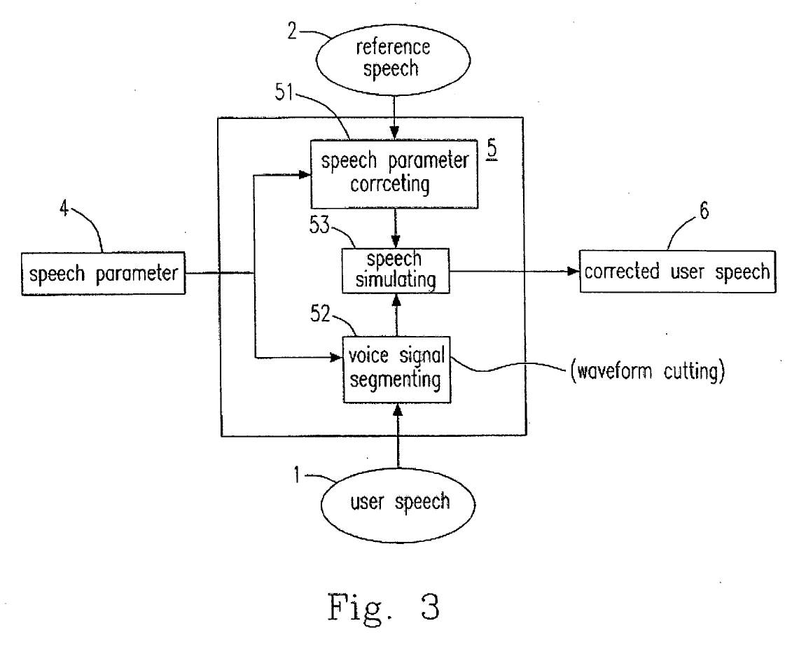

Please refer to FIG. 3, which illustrates how to correct speech in the present invention The speech correcting 5 is a simulation method that simulates the reference speech 2 based on the user speech 1 through a speech simulating 53, thereby forming the corrected user speech 6. Furthermore, the speech simulating 53 in the speech correcting 5 integrates the speech parameter 4, the reference speech 2, and the user speech 1. The speech parameter 4 is produced after the speech analysis 3 in FIG. 2. When the speech parameter 4 enters the speech correcting 5, there are two ways generated. One is that the speech parameter 4 cooperates with the reference speech 2 to perform a speech parameter correcting 51 so as to find out the difference therebetween. The other is that a voice signal segmenting 52 (a waveform cutting) is performed based on the speech parameter 4. It also means that the speech parameter 4 will be the standard to segment the user speech 1 in the voice signal segmenting 52 (the waveform cutting). Then, in the speech simulating 53, a specific property necessary to be corrected will be found from the user speech 1. When the speech parameter correcting 51 and the voice signal segmenting 52 are finished, the speech simulating 53 is performed. Then, the present invention produces a corrected speech with the user's voice after the speech simulating 53 is finished. Additionally, the sequence of the speech parameter correcting 51 and the voice signal segmenting 52 described above is exchangeable. It doesn't matter which one is performed first. Also, both of the speech parameter correcting 51 and the voice signal segmenting 52 could be performed simultaneously.

Of course, in the speech correcting 5, the selected speech parameter 4 to be corrected can be adjusted individually. The present invention providing a gradual method is a very good learning manner for the user unfamiliar with the language. The user won't be helpless as hearing the sample speech built in the conventional language learning software. The speech correcting method of the present invention uses the speech of the user as a standard for correction. Through the present invention, the mistakes in one or all of the properties of the user speech 1 will be corrected through the speech correcting 5. Then the present invention produces a correct speech, the corrected user speech 6, so the user will feel familiar to hear his voice with the correct speech. Because the user is most familiar with his own voice, when the present invention pronounces the correct speech with the user's voice, the user can realize his defects and correct them. Furthermore, since the user knows his own voice so well, when he hears the speech generated from the present invention, he can understand how to cooperate with the corrected user speech 6 and correct his physical reactions with respect to the speech, e.g. the mouth shape, the tongue position, and the vocal cords vibration. Hence, the present invention surely has a better language learning effect than that of the conventional method.

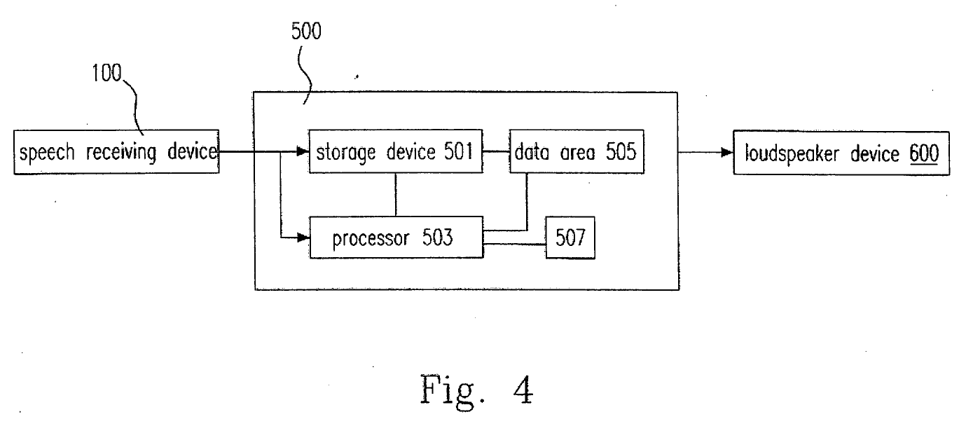

Please refer to FIG. 4, which is an interactive speech correcting device of the present invention. The present invention includes a speech receiving device 100 for receiving an external speech. The speech receiving device 100 can be a microphone socket only, and the user can select any microphone he likes or the microphone could be built in the present invention. Additionally, the present invention further comprises a controller 500, which is connected to the speech receiving device 100 and contains a reference speech. The controller 500 corrects the external speech based on the reference speech and produces a corrected speech. Furthermore, the present invention comprises a loudspeaker device 600 for outputting the corrected speech. The loudspeaker device 600 can be a loudspeaker or a loudspeaker socket. If the loudspeaker device 600 is a loudspeaker socket, the user can select any loudspeaker he likes. The corrected speech contains the properties of the original external speech, where only the erroneous portions of the original external speech are corrected. Therefore, the user can hear the correct speech with his own voice from the loudspeaker device 600.

Please refer to FIG. 4 again. For achieving the correcting effects, the controller 500 further comprises a storage device 501 and a processor 503. The storage device 501 contains the reference speech and stores the external speech and the corrected speech. The processor 503 is electrically connected to the storage device 501 for correcting the external speech as the corrected speech. Moreover, the storage device 501 further comprises a data area 505 for storing the reference speech.

Furthermore, an original property is extracted from the external speech by the controller 500. The original property is further separated to an original phoneme, an original length, an original volume, and an original intonation. Thus, the controller 500 can respectively and directly correct each property. Besides, an important characteristic of the present invention is to correct the speech gradually. Therefore, the controller 500 can only select one of the original phoneme, the original length, the original volume, and the original intonation to be corrected.

Besides, the controller 500 further comprises a scale controller 507, which can correct the selected properties in a gradual way. That is, it can control the correcting scale to prevent the user from feeling inadaptable caused by the difference between the corrected speech and his own voice.

Additionally, for having a basis to be the reference to correct the external speech (i.e. the user speech), the reference speech stored in the controller 500 further comprises a reference phoneme, a reference length, a reference volume, and a reference intonation. Hence, the four reference properties are compared with the original phoneme, the original length, the original volume, and the original intonation of the external speech respectively so as to decide which property is to be corrected and the correcting scale therefor.

In conclusion, the present invention allows the user to hear the correct speech with his own voice. In another words, the present invention can generate the correct speech with the user's own voice. Thus, when the user hears the correct speech with his own voice from the device of the present invention, he will feel friendly. Because the user is most familiar with his own voice, when he hears the correct speech with his own voice, it would be much easier for him to find out his speech defects and improve them thereby That is, the user can understand more exactly how to improve his physical actions such as the mouth shape, the tongue position, and the vocal codes vibration based on the corrected user speech 6. Therefore, the present invention is advantageous over the conventional language learning software.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present application which is defined by the appended claims.

What is claimed is:

1. An interactive speech correcting method, comprising steps of:
(1) providing a reference speech;
(2) receiving a user speech;
(3) analyzing said user speech and said reference speech;
(4) creating a speech parameter;
(5) performing a speech correction by using said speech parameter and said user speech; and
(6) outputting a corrected speech.

2. The method according to claim 1, wherein said step (5) further comprises a contrast between said speech correction and said reference speech.

3. The method according to claim 1, wherein said corrected speech is a corrected said user speech.

4. The method according to claim 1, wherein said reference speech comprises a reference phoneme, a reference length, a reference volume, and a reference intonation.

5. The method according to claim 4, wherein said user speech comprises an original phoneme, an original length, an original volume, and an original intonation.

6. The method according to claim 6,wherein said step (5) is performed by correcting said original phoneme, said original length, said original volume, and said original intonation on the basis of said reference phoneme, said reference length, said reference volume, and said reference intonation.

7. The method according to claim 6, wherein said step (5) is performed by correcting one selected from the group consisting of said original phoneme, said original length, said original volume, and said original intonation to proceed correcting.

8. The method according to claim 1, wherein said reference speech has a reference timbre and said user speech has an original timbre, and said step (5) corrects said reference timbre of said reference speech to make it become the same with said original timbre of said user speech to output through said step (6).

9. An interactive speech correcting method, comprising steps of:
(1) receiving a user speech;
(2) correcting said user speech to form a new user speech; and
(3) outputting said new user speech.

10. The method according to claim 9, wherein said user speech comprises an original phoneme, an original length, an original volume, and an original intonation.

11. The method according to claim 10, wherein said step (2) is based on a reference speech.

12. The method according to claim 11, wherein said reference speech has a reference phoneme, a reference length, a reference volume, and a reference intonation and said step (2) is based on said reference speech.

13. The method according to claim 12, wherein said step (2) further comprises a step (2-1): correcting one selected from the group consisting of said original phoneme, original length, original volume, and original intonation.

14. The method according to claim 13, wherein said method after said step (2-1) further comprises a step (2-2): deciding a correcting scale based on said selected item of said step (2-1).

15. The method according to claim 9, wherein said new user speech is a corrected voice of a user.

16. An interactive speech correcting device, comprising:
a speech receiving device receiving an external speech;
a controller connected to said speech receiving device and comprising a reference speech therein; and
a loudspeaker outputting a corrected speech based on said reference speech.

17. The device according to claim 16, wherein said controller comprises a storage device containing said reference speech, said external speech and said corrected speech, and a processing unit electrically connected to said storage device and correcting said external speech to form said corrected speech.

18. The device according to claim 16, wherein said controller separates an original property from said external speech.

19. The device according to claim 18, wherein said original property includes properties of an original phoneme, an original length, an original volume, and an original intonation.

20. The device according to claim 19, wherein said controller only selects a candidate property to be corrected from the group consisting of said original phoneme, said original length, said original volume, and said original intonation properties.

21. The device according to claim 20, wherein said controller further comprises a scale controller performing a staged correction to said candidate property.

22. The device according to claim 20, wherein said reference speech further comprises a reference phoneme, a reference length, a reference volume, and a reference intonation to be a reference for said candidate property.

23. An interactive speech correcting method, characterized in that an outputting standard speech is performed by simulating a user speech.

24. The method according to claim 23, wherein said simulating step comprises steps of:
(1) setting a reference speech;
(2) receiving said user speech; and
(3) producing a corrected user speech by simulating said reference speech based on said user speech.

25. The method according to claim 24, wherein said step (1) further comprises a step (0): providing a speech parameter.

26. The method according to claim 25, wherein said speech parameter of said step (0) is gained from analyzing said user speech on the basis of said reference speech.

27. The method according to claim 25, wherein said step (2) further comprises a step (2-1): correcting said speech parameter on the basis of said reference speech.

28. The method according to claim 25, wherein said step (2) further comprises a step (2-2): segmenting said user speech on the basis of said speech parameter.

29. The method according to claim 28, wherein said segmenting step is performed by cutting a wave pattern of said user speech.

30. The method according to claim 25, wherein said step (2) comprises steps of:
(2-1) correcting said speech parameter on the basis of said reference speech; and
(2-2) segmenting said user speech on the basis of said speech parameter, wherein a sequence of said step (2-1) and said step (2-2) is exchangeable.

31. The method according to claim 24, wherein said reference speech comprises a reference phoneme, a reference length, a reference volume, and a reference intonation.

32. The method according to claim 31, wherein only one from the group consisting of said reference phoneme, said reference length, said reference volume, and said reference intonation is selected to be corrected at a time.

33. The method according to claim 32, further comprising a step of modulating a scale of the selected one.

34. The method according to claim 31, wherein said speech parameter comprises an original phoneme, an original length, an original volume, and an original intonation.

35. The method according to claim 34, wherein only one from the group consisting of said original phoneme, said original length, said original volume, and said original intonation is selected to be corrected at a time.

36. The method according to claim 25, further comprising a step of modulating a scale of the selected one.
